(19) United States
(12) Patent Application Publication
(10) Pub. No.: US 2024/0099339 A1
(43) Pub. Date: Mar. 28, 2024

(54) PROCESS AND SYSTEM FOR COOKING AGAVE PIÑAS TO PRODUCE DISTILLED BEVERAGES

(71) Applicant: POZZI LEOPOLDO S.R.L., Meda (MB) (IT)

(72) Inventors: Alberto POZZI, Carate B.za (MB) (IT); Pierlorenzo BOWEN, Carate B.za (MB) (IT); Flavio CONVENTO, Giussano (MB) (IT)

(21) Appl. No.: 17/969,606

(22) Filed: Oct. 19, 2022

(30) Foreign Application Priority Data
Sep. 28, 2022 (IT) 102022000020004

(51) Int. Cl. A23L 5/20

(52) U.S. Cl. CPC A23L 5/21

(57) ABSTRACT

It is disclosed a process for cooking agave piñas (102) to produce distilled beverages comprising the step of placing a plurality of portions of agave piñas in an autoclave (101), increasing the temperature inside the autoclave in order to start the cooking of the agave piñas (102) with injection or production of steam inside said autoclave, draining at least one batch of liquid solution from the plurality of portion of the agave piñas (102) from the autoclave (101), cooling of the agave, either within or outside of the autoclave. The process is characterized in comprising at least one step of removing gaseous content from said autoclave.

This application claims priority to and the benefit of Italian Patent Application 102022000020004 filed 28 Sep. 2022 the content of which is incorporated herein by reference in its entirety.

### FIELD OF INVENTION

Agave piñas is the base ingredient of the distilled beverage of Tequila, Metzcal, and other distilled spirits. In particular, a type of agave which is preferably used is the blue agave. The presence of sugars such as fructose, glucose and sucrose in the core portion of the plant is the main characteristic which make it suitable for the preparation of alcoholic beverages. Since the global demand of distilled beverages has increased over the last decades, an industrial scale production of spirits, and in particular, agave derived spirits, ensued.

It has to be immediately noted that the term agave piñas will be used herein to indicate the core portion of the agave plant, from which the leaves are at least partially or completely removed.

It has to be immediately noted that even if in the following particular reference will be made to the agave piñas, the present invention can be also used for cooking different vegetables or plants, for example those used for the production of distilled beverages.

### KNOWN PRIOR ART

U.S. Ser. No. 10/106,764 discloses a process for the production of distilled beverages by steaming the agave piñas for 30 to 40 hours in a stone cooking oven.

US2002119217 disclose a process in which agave piñas are softened in steam rooms or slow-bake ovens for 50-72 hours. This approach bakes the agave to process its natural juices, softens the fibres and helps keep the agave from caramelizing, which adds darker and bitter flavours to the juice and reduces the agave sugars. Baking in ovens also helps retain more of the natural agave flavours. Cooking processes are also known in the art wherein the agave piñas, are first harvested, subsequently the agave piñas are chopped in several pieces and placed in an autoclave, where the temperature is gradually raised to around 105° C. A first batch of liquid solution is generated by the cooking of the agave piñas, drained and discarded.

After discarding this first batch of liquid solution, the temperature is kept at 110° C. for roughly 10 hours in order to completely cook the agave piñas.

After the cooking, a final batch of liquid solution is obtained, drained from the autoclave and stored in order to be further processed together with the cooked agave to obtain distilled beverages.

The agave piñas, after cooking is completed, are subsequently removed from the autoclave and left in an open and ventilated environment in order to cool the cooked agave piñas for a number of hours, depending on environmental conditions. During the cooking process in the autoclave, the agave piñas are cooked through steam injection.

The steam injection, if done with presence of air in the autoclave, has several drawbacks such as a relatively inefficient heat transfer to the core of the agave piñas. Additionally steam injection is entering the autoclave at a higher temperature and higher pressure with respect to the surrounding environments.

As a result, a superheated steam environment is generated in the autoclave such that the condensation of steam on the surface of the agave piñas is not enhanced, thus causing a potential burning of the outer layer of the piñas and a rather incomplete cooking of the inner layers of the agave, therefore providing an inhomogeneous cooking of the agave between inner, intermediate and outer layer of the agave. In fact, once steam is introduced in the autoclave the air will end up compressing also within the material, thus making it extremely difficult for the stream to reach the agave inner parts.

Additionally, the amount of oxygen present in the autoclave, during steam injection will enhance sugar oxidation (caramelization of sugars) which would not therefore be usable for the later process of Tequila, or any other distilled product manufacturing, as it cannot be subject to subsequent fermentation.

Overall, a process of cooking comprising a simple steam injection is a time-consuming, inefficient process in which, additionally, some of the main aromatic compounds could be lost during the cooking process itself.

Another drawback of the current method for processing agave piñas to produce distilled beverages is the time of cooling of the cooked agave piñas.

Currently, the method of cooling consists of placing the cooked agave piñas in an open and ventilated environment for a relatively long period.

The cooling of the cooked agave piñas is therefore based on induced convection by air surrounding the cooked agave piñas as well as the natural thermal radiation from the piñas themselves. This approach is therefore time consuming. Additionally, a considerable amount of space needs to be used to store the cooked agave piñas which also imply the use of a relative high amount of work force for logistics reasons.

This approach has also another additional drawback related to the variability of meteorological and seasonal conditions which could create a considerably unpredictable time needed to cool the cooked agave piñas.

This method of cooling operation also induces a differential temperature level between the inner and outer parts of the agave, as well as inconsistencies between the final temperature reached by each single piña/slice of piña within the same batch and between different batches.

It is thus an object of the present invention to solve the above-mentioned drawbacks of the known cooking process.

It is an object of the present invention to provide a process for cooking agave piñas having a homogeneous heating of the agave piñas.

It is a further object of the present invention to provide an efficient and homogeneous cooling of the cooked agave piñas to reduce the cooling time needed after cooking. Both of these objects are aimed at both raising the efficiency, as well as the quality and repeatability of the final product achieved from each cooking and cooling process.

### SUMMARY OF THE INVENTION

These and other objects are achieved by the cooking process and apparatus according to the independent claims, while preferred aspects are recited in the respective dependent claims.

In particular, an aspect of the present invention relates to a process for cooking agave piñas to produce distilled beverages comprising the step of:
a) placing a plurality of portions of agave piñas in an autoclave,
b) increasing the temperature inside the autoclave in order to start the cooking of the agave piñas with injection or production of steam inside the autoclave,
c) draining at least one batch of liquid solution from the plurality of portion of the agave piñas from the autoclave,
d) cooling the agave, either within or outside the autoclave.

The process of cooking the agave piñas according to the invention is characterized in comprising at least one step of removing gaseous content from said autoclave. As mentioned above, in step a) a plurality of portions of agave piñas are placed in an autoclave. According to a possible embodiment, the agave piñas may be cut in a plurality of portions, for example before placing them in the autoclave. Advantageously, in step a) the higher the plurality of cut portions of the agave piñas and the relative reduction of their size, the higher will be the heat transfer inside the autoclave and the shorter will be the time needed to cook the plurality of portions of agave piñas and the shorter will be the time needed to cool the plurality of portions of the agave piñas.

The process comprises at least a step of removing gaseous content from said autoclave. Advantageously the less air is present in the autoclave the shorter is the time of cooking of the agave piñas.

Additionally, the less air is present in the autoclave, the more homogeneous is the cooking of the agave piñas.

In other words, the outer layer, the intermediate layer and the inner layer of the agave piñas are cooked homogeneously.

Finally, the less air is present in the autoclave the lower will be the risk of oxidizing sugars and aromatic compounds present inside the agave piñas and lower the risk of having caramelized sugar in the cooked agave piñas. Caramelization (or oxidation) of sugars during cooking is the process in which potentially fermentable sugars are transformed into non fermentable sugar. Furthermore, throughout oxidation some aromatic compounds might be lost.

Advantageously, as further explained in greater detail here below, the at least one step of removing the gaseous content from said autoclave allows providing a process for cooking agave piñas with a homogeneous heating thereof thanks to an environment which is as close as possible to a saturated steam environment.

According to an aspect, a first step of removing gaseous content is carried out before any heating up of the autoclave and/or before any heating up of the plurality of portion of agave piñas.

According to a possible aspect, the step of removing gaseous content is carried so that vacuum is applied inside the autoclave, preferably by a vacuum pump.

According to a possible aspect, the process comprises at least two steps of removing gaseous content from the autoclave.

According to an aspect, the process also comprises at least two steps of increasing the temperature, wherein a first step of removing gaseous content is carried before the first step of increasing temperature and a second step of removing gaseous content is carried out after the first step of increasing temperature and before the second step of increasing temperature.

An advantage of these aspects is that after a first step of removing gaseous content most of the air is removed from the autoclave, preferably 90% or more, more preferably about 90% of the gaseous content is removed from the autoclave.

More in detail, after removing gaseous content, preferably carried out so that about 90% of the air is removed, only 10% of the volume of the autoclave is filled with air. The autoclave is then filled with steam, such that the autoclave is filled with a mix of air and of steam. The second step of removing gaseous content is therefore applied to the said mix of air and steam.

This second operation will therefore remove the 90% of the gaseous mixture leaving, at the end of the operation, only a fraction of the oxygen present in the autoclave before the operation.

Advantageously the result is an almost saturated steam environment able to enhance a homogeneous distribution of steam around and inside the agave piñas, maximising therefore the homogeneity of cooking of outer layer, intermediate layer and inner layer of the agave piñas as in an almost saturated steam environment the steam heats homogeneously all of the semi-permeable material present inside the autoclave.

As a result, in a saturated steam environment wherein the presence of air is minimized by the vacuum applied, only the steam is in direct contact with the agave piñas, maximizing therefore the heat transfer between the steam and the agave piñas, resulting in a shorter time needed for cooking the agave piñas.

Additionally, the saturated steam, during the cooking of the agave piñas, minimizes the risk of burning or caramelizing the agave piñas and instead provides a homogenous cooking of the outer, intermediate and outer layer of the agave piñas while avoiding losses of fermentable sugars and aromatic compounds.

Advantageously, the process according to the invention allows to obtain homogeneously cooked and cooled agave piñas, with the highest efficiency of hydrolyzation of sugars, while maintaining at a minimum sugar oxidation/burning.

Another advantage of a saturated steam environment is that, differently from the current state of the art, the cooking temperature of the agave piñas in the inner layer is reached in a shorter time, resulting therefore in increased production volumes of distilled beverages in a shorter time.

According to an aspect of the present invention, the temperature reached in the second step of increasing temperature is higher than the temperature reached in the first step of increasing temperature.

According to an aspect of the present invention, the step of removing gaseous content reduces the maximum pressure difference with respect to the theoretical fully saturated steam environment at any given temperature within the autoclave.

As an example, at a cooking temperature of 110° C. with the present invention, an autoclave internal pressure between 1.43 and 1.52 Bar is achieved, while in the method known in the art, cooking pressures at the same temperatures will exceed 2 Bar. Advantageously, the above-mentioned reduced pressure difference value guarantees keeping the inner volume of the autoclave wherein the agave piñas are arranged in an almost saturated steam environment.

According to an aspect, the temperature reached in the first step of increasing temperature is a temperature value lower than the cooking temperature of the agave.

According to an aspect, after this first heating up has been achieved, the procedure continues with a second removal of gaseous content and a subsequent second step of increasing temperature.

According to an aspect, either during the first heating step, or during a following heating step, or after cooking, at least one more step of extraction of liquids produced by the agave is carried out.

As an example, when the temperature reached in the second step of increasing temperature, is between 90° C. and 110° C., preferably at a temperature of 105° C., a first batch of liquid secreted by the agave is removed from the autoclave.

According to an aspect, the process for cooking the agave piñas comprises a further step of heating up and maintaining a temperature value desired for the cooking, usually between 90° C. and 120° C. and kept for a time interval between 6 hours and hours, preferably of maintaining a temperature value of 110° C. and kept for a time interval of about 10 hours, or less.

According to an aspect, the cooling of the agave comprises a vacuum cooling step.

According to an aspect, the vacuum cooling step is carried out by reducing the pressure within the autoclave.

According to an aspect, the temperature of the steam inside the autoclave is decreased, preferably by means of a heat exchanger, and in particular a circulating cooling medium such that at least a portion of the steam within the autoclave condensates and the pressure in the autoclave is reduced.

As the pressure in the autoclave is reduced, also the portions of agave piñas will reduce their temperature by evaporation of their aqueous content.

In other words, the cooling process according to the invention comprises a step of lowering the temperature of the steam contained in the autoclave at the end of the cooking steps (for example steam at 110° C., 1.43 Bar), preferably by means of the circulation of a cooling medium, e.g. water, by means of a heat exchanger arranged within or outside the autoclave. As the temperature of the steam is lowered, a portion of the steam will condensate, therefore lowering the pressure of the system, according to the steam saturation line. In fact, not only the temperature is reduced, but the density of steam is also reduced. As a result, the pressure will also decrease thus also cooling down the agave present inside the autoclave forcing the evaporation of its aqueous content and thus absorbing energy trough loss of latent heat, from the mass thereof.

In this step, vacuum cooling allows to lower the temperature inside the autoclave which means that the steam inside the autoclave decrease its temperature and a portion of it will condensate and the pressure in the autoclave is reduced. As the pressure in the autoclave is reduced, also the portions of agave piñas will also reduce their temperature.

This process takes away energy in the form of heat from the agave piñas, which ensures rapid and uniform cooling of the outer layer, intermediate layer and inner layer of the cooked agave piñas. Additionally vacuum cooling allows to recover machine energy costs with respect to the traditional cooling technologies.

In fact, placing a heat exchanger inside or outside the autoclave, and using cold cooling medium inside it, we will cool down the steam, as well as heating up of the cooling medium that can be used in other processes, possibly within the same distilled beverage production plant. This is effectively a heat recovery process, where we simply recover the energy present in the steam (which after cooking in the process known in the art is simply discarded).

Preferably, the step of vacuum cooling is carried out until the temperature inside the core portion of the plurality of agave piñas is at a temperature between 50° C. and 70° C. and at an absolute pressure between 0.1 to 0.3 Bar, preferably at a temperature of 60° C. and at an absolute pressure of 0.2 Bar. Absolute pressure is typically defined with reference to a perfect vacuum at absolute pressure equal to 0 Bar.

According to a possible aspect, the step of reducing the pressure within the autoclave is performed by direct removing gaseous content or by decreasing gaseous content in the autoclave.

Additionally, according to a further aspect, the reduction of pressure within the autoclave can be provided especially when the temperature of the steam has already been lowered by the heat exchanger, by directly removing gaseous content from the autoclave.

This step can be carried out for example when the temperature of the steam within the autoclave has been already lowered by means of the cooling medium circulating in the heat exchanger, thus the temperature differences between the cooling medium and the steam within the autoclave is limited.

In this case a direct reduction of pressure, by removing gaseous content from the autoclave, for example by means of a vacuum pump, allows to further reduce the pressure in shorter time and therefore cooling the agave within the autoclave in shorter time if compared with the cooling time required if the cooling is performed only by the heat exchanger with a cooling medium with limited temperature difference with the temperature already reached within the autoclave.

The present invention also relates to a system for cooking agave piñas to produce distilled beverages, preferably by carrying out the process herein disclosed and/or claimed, the system comprises an autoclave inside which the agave piñas are arranged in at least one basket, the autoclave comprising a drain line, a gaseous content removing element, preferably comprising a vacuum pump, a steam generation device (e.g. a boiler) to produce steam to be injected in the inner volume of the autoclave, or a steam generation device internal to the autoclave to produce steam. The system further comprises a programmable logic control unit.

According to an aspect, the system further comprises a cooling element. Preferably, the cooling element comprises a heat exchanger comprising a cooling circuit wherein a cooling medium, preferably water, is circulated.

According to an aspect the heat exchanger is arranged inside the autoclave but can also be placed outside it, with adequate connections to the body of the autoclave. Advantageously, this arrangement allows to extract heat from the agave piñas during the vacuum cooling while a receiver can be placed under the heat exchanger to allow the collection of the condensate. Said condensate can be reused and fed for example to the boilers used to generate the steam or in any other process which requires preheated distilled water.

According to an aspect, the system further comprises at least one reservoir to recover condensate and/or other liquids produced by the cooking or cooling of agave piñas in the reservoir.

According to an aspect, the system further comprises one or more temperature sensors. Thermal sensors allow to measure the temperature inside the autoclave and/or the temperature of at least part of the agave piñas.

According to an aspect, said thermal sensors allow to measure the temperature of the agave piñas in at least one area selected from the outer, intermediate and inner layer, or a combination of two or more of said areas, in order to optimize the cooking and/or cooling parameters such as for example cooking and/or cooling time.

Advantages herein disclosed with reference to the process for cooking agave applies mutatis mutandis to the system for cooking agave.

In general, it has to be noted that what is herein disclosed and/or claimed with reference to the process for cooking agave can be applied to the system for cooking agave, and vice versa.

The present invention further relates to a process for cooking agave piñas to produce distilled beverages comprising the steps of cooking a plurality of portions of agave piñas, obtaining at least a batch of liquid solution from the plurality of portion of the agave piñas, vacuum cooling the cooked agave piñas.

It has to be noted that the step of vacuum cooling can be performed independently from the type of cooking of the agave piñas used. In particular, independently from the cooking methodology used for cooking the agave piñas by increasing the temperature thereof, such as for example the cooking methodology herein disclosed with reference to the cooking by removing gaseous content from the autoclave, a vacuum cooling step can be used with different cooking steps.

For example, the step of vacuum cooling herein disclosed and/or claimed (see for example claims 20-24) can be applied to cooking methods known in the art, and in general to cooking methodology not requiring a removal of the gaseous content, while still allowing to obtain the advantages herein disclosed.

Advantageously, the step of vacuum cooling the cooked agave piñas allows reducing the temperature of the cooked agave piñas in a shorter time compared with method known in art where typically the reduction of temperature of the cooked agave piñas is obtained by induced convection by air surrounding the cooked agave piñas as well as the natural thermal radiation from the piñas themselves.

Additionally, the step of vacuum cooling, allows obtaining a homogeneous reduction of temperature of the cooked agave piñas as the step of vacuum cooling takes away energy in the form of heat from the agave piñas, which ensures rapid and uniform cooling of the outer layer, intermediate layer and inner layer of the cooked agave piñas. According to a possible aspect, said vacuum cooling of the cooked agave piñas are arranged inside a closed container, preferably an autoclave, the vacuum cooling step is carried out by reducing the pressure within the container.

Advantageously, the reduction of pressure inside the container allows providing a reduction of temperature to evaporate the aqueous content inside in the cooked agave piñas and therefore reducing the time needed to cool the agave piñas.

According to a possible aspect, the temperature of the steam inside the container is decreased, preferably by means of a heat exchanger, in particular a circulating cooling medium, and at least portion of the steam within the container condensates and the pressure in the container is reduced.

Advantageously, the reduction of temperature of the steam inside the container by means of heat exchanger and a circulating cooling medium allows to reduce the time needed to cool the agave piñas. As the temperature of the steam is reduced a portion of the steam condensates and the density of the steam is also reduced. As a result, the pressure inside the container is reduced and the temperature of agave piñas is reduced by forcing the evaporation of their aqueous content thus absorbing energy through loss of latent heat of the mass of the agave piñas. Additionally the condensate produced can be reused and fed, for example, to the boilers used to generate steam or in any other process which requires preheated distilled water.

According to a possible aspect, the step of reducing the pressure within the container is performed by carrying out the removal or by decreasing gaseous content from the container.

Advantageously, the reduction of pressure within the container can reduce the time of cooling of the agave piñas especially when the temperature of the steam has already been lowered by the heat exchanger, by directly removing gaseous content from the container.

Advantageously this can be particularly time saving in cooling the cooked agave piñas in the cases in which the temperature of the steam within the container has been already lowered by means of the cooling medium circulating in the heat exchanger, thus the temperature differences between the cooling medium and the steam within the autoclave cannot be further minimized. In this case a direct reduction of pressure, by removing gaseous content from the container, for example by means of a vacuum pump, allows to further reduce the pressure in shorter time and therefore cooling the agave within the container in shorter time if compared with the cooling time required if the cooling is performed only by the heat exchanger with a cooling medium with limited temperature difference with the temperature already reached with the autoclave.

According to a possible aspect, the step of vacuum cooling is carried out until the temperature inside the core portion of the plurality of the agave piñas is at a temperature between 50° C. and 70° C. and at an absolute pressure between 0.1 to 0.3 Bar, preferably at temperature of 60° C. and at an absolute pressure of 0.2 Bar.

### BRIEF DESCRIPTION OF THE DRAWINGS

Further aspects and advantages in accordance with the present invention will be discussed more in detail with reference to the enclosed drawings, given by way of non-limiting example, wherein:

FIG. 1 shows a schematic view of a possible embodiment of a system for performing a process for cooking agave piñas to produce distilled beverages.

FIG. 2 shows the inside volume of an autoclave and a heat exchanger in proximity to the lateral walls of the autoclave comprising agave piñas inside a basket and the thermal probes which allow to measure the temperature on the outer, intermediate and inside layer of the agave piñas.

FIG. 3 shows the time needed to cool the cooked agave piñas according to the process of the present invention carried out in a testing apparatus compared with a process known in the art.

FIG. 4 shows the time needed to reach the temperature of cooking the inner and outer layer of the agave piñas according to a process known in the art.

FIG. 5 shows the time needed to reach the temperature of cooking in the inner, intermediate and outer layer of the agave piñas according to the present invention carried out in a testing apparatus.

FIG. 6 shows the average temperature difference (delta) within the agave throughout cooking process according to the present invention carried out in a testing apparatus and according to a method known in the art.

FIG. 7 shows the extraction efficiency of sugars from the agave piñas according to the present invention carried out in a testing apparatus compared with a method known in the art.

FIG. 8 shows the reduced amount of fermentable sugar lost due to burning and/or oxidation according to the present invention carried out in a testing apparatus compared to a method known in the art. The graph shows an example of furfural found when oxidation occurs according to the present invention and according to a method known in the art.

### DETAILED DISCLOSURE OF THE PRESENT INVENTION

In the following description the term “gaseous content” refers to a gas solution comprising either only air, or a mix of air and steam or only steam.

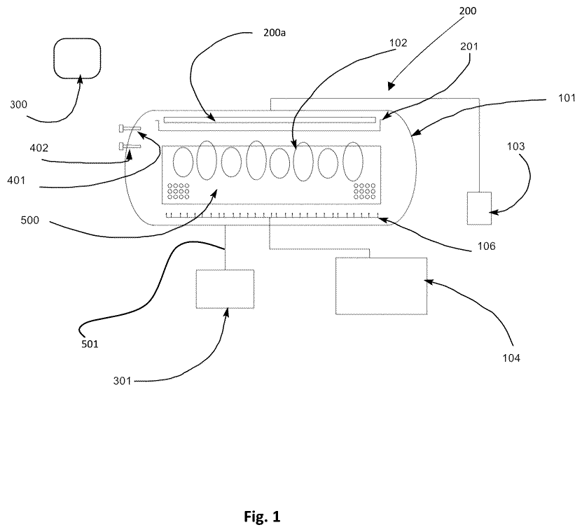

Herein the term “removing gaseous content” it is interchangeably used with the term “vacuum”, with the meaning of removing a gaseous content from the inner volume of the autoclave. An exemplary embodiment of the system suitable to carry out the process for cooking agave piñas is described here below. An embodiment of the system 100, as for example shown in FIG. 1, comprises an autoclave 101. Typically said autoclave is built in food-grade stainless steel where the agave piñas portions 102 can be placed in order to be cooked.

The system further comprises one or more perforated baskets 500. Said basket 500 is a container for the agave piñas 102. Advantageously the autoclave 101 is connected to a drain line 501 to allow collection of the liquid solutions during and at the end of the cooking process of the agave piñas 102 to be further processed. Extracted liquids can be collected through the drain line 501 in a reservoir 301. The system may be provided with one or more reservoir in order to collect separately different portions of liquids extracted during the cooking and/or cooling steps.

The system further comprises a gaseous content removing element 103 to provide a reduced pressure (vacuum) inside the autoclave 101. According to an embodiment the gaseous content removing element comprises vacuum pump, more preferably liquid ring vacuum pump. However, other means of gaseous removal known in the art can be alternatively used.

Typically, a liquid ring vacuum pump comprises a vane impeller which rotate inside a cylindrical portion. Said vane impeller has a rotational axis eccentric with respect to the cylindrical portion. The cylindrical portion further comprises a liquid ring inside. Gaseous content entering in the liquid ring vacuum pump from an inlet port is entrapped between the liquid ring and the vane impeller and discharged from the outlet port of the liquid ring pump producing vacuum inside the autoclave.

The system further comprises a steam generation device 104, e.g. a boiler. According to an embodiment, said steam generation device 104 could produce steam outside the autoclave 101 and subsequently the steam is injected inside the autoclave 101 through a plurality of conduits 106. Alternatively, according to a different possible embodiment not shown in the figures, the steam generation device 104 could produce steam directly inside the autoclave 101.

The system further comprises one or more thermal and pressure sensors (herein also indicated as thermal probes) 401, 402 allowing a temperature and pressure detection in the inner volume of the autoclave and/or of at least one portion of the agave piñas arranged inside the autoclave.

For example, according to a possible embodiment, one or more temperature sensors are arranged to detect temperature in the inner volume of the autoclave so as to provide a temperature signal used to set and/or modify at least the heating and cooking temperature during each step of the process, e.g. vacuum, steaming, and pressure control.

Thermal probes 401 can be also provided to measure the temperature of at least one portion of the agave arranged within the autoclave, for example at least one area selected from the outer layer, intermediate layer and inner layer of the agave piñas 102, or a combination of two or more of said areas.

The system further comprises a programmable logic control unit (plc) 300. Advantageously said control unit 300 allows to control the vacuum steps, the passage of steam from the autoclave 101 and the steam boiler 104.

Additionally, the control unit 300 controls collected data from the thermal and pressure probes 401, 402. Advantageously the control unit 300 can therefore receive a signal indicative of the temperature of the agave piñas 102 and/or of the temperature and pressure inside the autoclave 101.

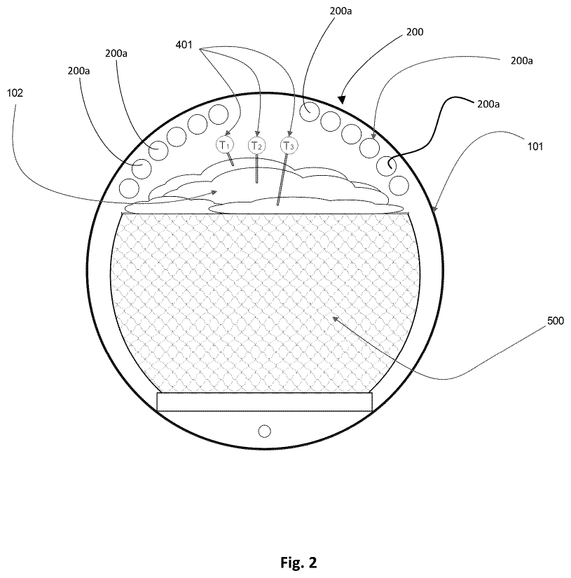

The system further comprises a cooling element 200. Preferably, said cooling element 200 comprises a heat exchanger 200a which, according to possible embodiments can be placed inside the autoclave 101 or outside the autoclave, and optionally a condensate receiver reservoir 201 preferably arranged within the autoclave volume, for example below the heat exchanger tubes. According to an embodiment, wherein the heat exchanger 200a is arranged inside the autoclave, the heat exchanger 200a comprises pipes laid inside the inner walls of the autoclave 101 as for example shown in FIG. 2.

Advantageously having the heat exchanger 200a inside the autoclave will reduce the time of cooling of the cooked agave piñas 102.

As mentioned, the invention further relates to a process for cooking agave piñas 102 to produce distilled beverages wherein the process comprises the step a) wherein the portions of agave piñas 102 are placed in an autoclave 101, a step b) wherein the temperature is increased in order to start cooking the agave piñas 102 with injection or generation of steam inside the autoclave 101, a step c) wherein at least one batch of liquid solution from the plurality of agave piñas 102 is drained from the autoclave 102, a step d) wherein the agave 102 is cooled either within or outside of the autoclave.

Additionally, the process comprises at least a step of removing gaseous content from the autoclave 101. Preferably the step of removing gaseous content is carried out so that vacuum is applied inside the autoclave by operating the gaseous content removing element 103, preferably by operating the vacuum pump. Preferably, a first step of removing gaseous content is carried out before any heating up of the autoclave 101 and/or any heating up of the plurality of portion of agave piñas 102. According to a possible preparatory step, the agave piñas 102 can be cut in a plurality of portions and placed in a basket 500. Preferably said basket 500 is in stainless steel.

During step a) the agave piñas 102 inside the basket 500 is placed in the autoclave 101. Thermal probes 401 are provided in order to measure the temperature inside the autoclave 101. Optionally, a pressure probe 402 can be provided to measure the pressure inside the autoclave 101.

The boiler 104 will then feed steam to the autoclave 101, which will gradually heat the agave piñas portions 102.

According to an aspect, the process comprises at least two steps of removing gaseous content from the autoclave 101.

According to an aspect, the process comprises at least two steps of removing gaseous content from the autoclave 101 and at least two steps of increasing temperature in the autoclave 101 wherein the first step of removing gaseous content is carried out before the first step of increasing the temperature and the second step of removing gaseous content is carried out after the first step of increasing the temperature and the second step of increasing temperature. Preferably the temperature reached in the second step of increasing temperature is higher than the temperature reached in the first step of increasing temperature.

Preferably, according to a possible embodiment, the temperature of the autoclave 101 reaches a temperature lower than the cooking temperature of the agave piñas 102, preferably between 60° C. and 70° C.

Advantageously this step will minimize the presence of air in the autoclave and maximize the presence of steam in the autoclave 101 having therefore the ability to better control the parameters of cooking of the agave piñas 102 inside the autoclave 101. A further step of removing gaseous content can be provided.

Before proceeding with removal of gaseous content, feeding of steam from the boiler 104 to the autoclave 101 should be halted.

Preferably said further step of removing gaseous content is carried out until an absolute pressure between 0.1 and 0.3 Bar (internal of the autoclave 101) is reached. Advantageously, this step will remove part of the steam previously injected inside the autoclave and the remaining air from the autoclave 101, thus obtaining an environment having only a minimum fraction of the air which was originally present.

After this step, feeding of steam from the boiler 104 to the autoclave 101 can be resumed, so to raise the internal temperature of the autoclave 101 and of the portions of agave piñas 102.

Preferably the temperature inside the autoclave is increased to a cooking temperature between 90° C. and 110° C. to allow removal of the first secreted liquids, preferably at a temperature of 105° C.

Preferably, after this second step of increasing the temperature, temperature inside the autoclave 101 is further increased and kept for the time needed to cook the agave piñas 102, for example the process comprises a further step of maintaining a temperature value between 90° C. and 120° C. and kept for a time interval between 6 hours and 15 hours, preferably of maintaining a temperature value of 110° C. and kept for a time interval of 10 hours or less.

As already mentioned above, advantageously in this step the autoclave will be substantially filled with steam while the presence of air is minimized.

As a result, an environment as close as possible to saturated steam is produced in the autoclave 101, by the steam boiler 104, which enhances a homogeneous distribution of steam around the agave piñas 102 contained in the autoclave 101, maximising therefore the cooking of outer layer, intermediate layer and inner layer of the agave piñas 102 the steam heat homogeneously all of the water molecules present inside the agave piñas 102 as well as its semi-permeable layers, therefore cooking them homogeneously.

As a result, a saturated steam environment wherein the presence of air is minimized in the autoclave 101 by the vacuum applied, only the steam is in direct contact with the agave piñas 102, maximizing therefore the heat transfer between the steam and the agave piñas 102, resulting in a shorter time needed for cooking the agave piñas 102.

Additionally, the saturated steam during the cooking of the agave piñas minimizes the risk of burning or caramelizing the agave piñas 102 and instead providing a homogenous cooking of the outer, intermediate and outer layer of the agave piñas 102.

Furthermore, the absence, partial or total, of air inside the autoclave 101, during cooking, ensures minimal losses of fermentable sugar due to oxidation (caramelization) and potentially reduces losses of aromatic compounds.

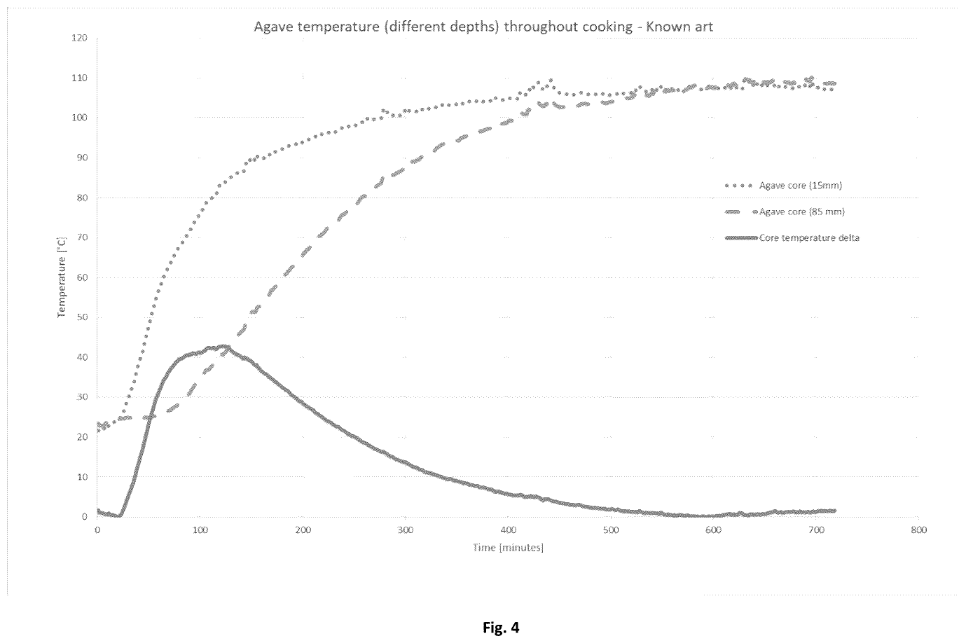

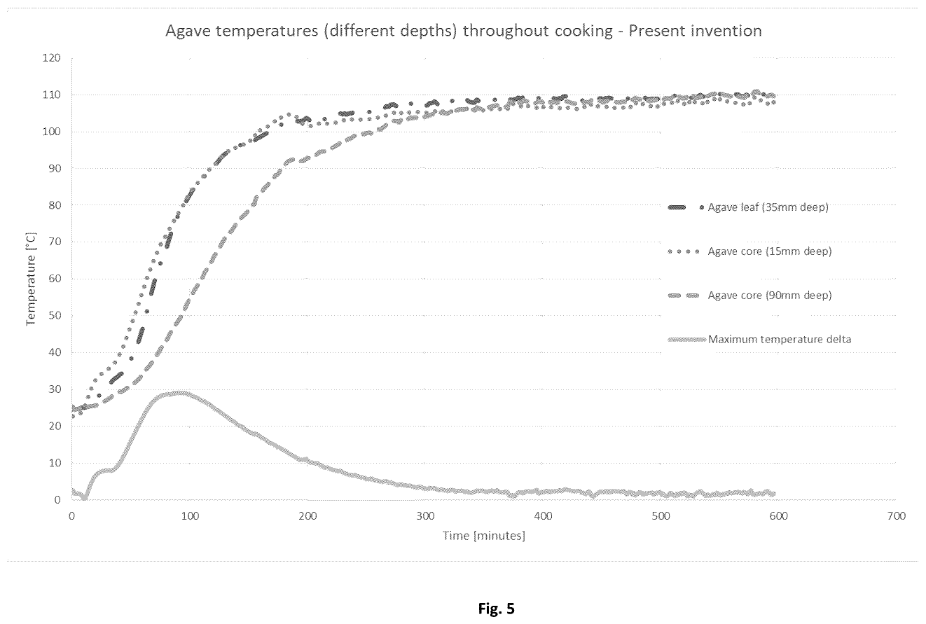

Another advantage of a saturated steam environment is that, differently from the current state of the art, the cooking temperature of the agave piñas in the inner layer is reached in a shorter time, resulting therefore in a potential increase of production volumes of distilled beverages as shown for example in FIG. 4-5 and table 1.

Table 1, which is referring to results gathered from a testing apparatus having a much slower steam production ability and reduced dimensions with respect to an autoclave used in the cooking process of high production volumes, here below, shows how the cooking temperature of 110° C. is reached in shorter time, especially referring to the inner layer of the agave, compared to a known cooking process without the step of removing of gaseous content from the autoclave. As shown a temperature of 110° C. is reached in 400 minutes in the process according to the invention, and is reached in 650 minutes in a known process.

TABLE 1

| | Without vacuum | With vacuum |
|---|---|---|
| Agave piñas | heating - Time to reach | heating - Time to reach |
| layer | 110° C. (mins) | 110° C. (mins) |
| Outer layer | 450 | 360 |
| Inner layer | 650 | 400 |

FIG. 4 shows the time needed to reach the temperature of cooking according to a method known in the art in the inner and outer layer of the agave piñas. FIG. 5 shows the time needed to reach the temperature of cooking the inner, intermediate and outer layer of the agave piñas according to a method according to the present disclosure.

FIG. 5 shows how the increase of temperature is homogeneous for the three layers and the temperature is reached approximately after 360 minutes for the outer layer and 400 minutes for the inner layer. In FIG. 4 the time to reach the temperature of cooking is longer, approximately the time needed is 650 minutes for both the outer layer and the inner layer.

Comparing FIG. 4 and FIG. 5 it can be noticed that the gradient of increase of temperature is comparable in FIG. 5 for the outer layer, intermediate layer and inner layer while in FIG. 4 the outer layer (Agave core 15 mm) has a gradient of temperature increase higher than the gradient of temperature increase of the inner layer (Agave core 85 mm).

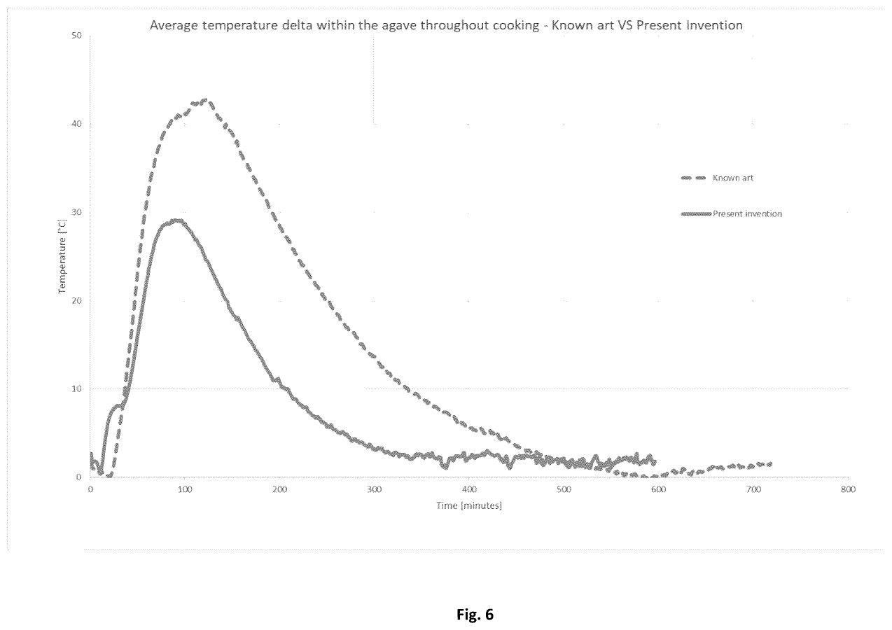

The better homogeneity of cooking in the present invention is clearly shown in FIG. 6, where the difference between inner and outer temperatures (of the agave portions 102) throughout the cooking process is compared between the known art and the present invention.

Advantageously, as shown in FIG. 6, in the process according to the invention the difference between inner and outer temperatures (of the agave portions 102) throughout the cooking process is reduced with respect to the temperature difference between inner and outer temperatures (of the agave portions 102) throughout a known cooking process. Additionally, in the process according to the invention the temperature difference between the inner and outer layer is minimized in a reduced amount of time with respect to the known process. In other words, in the process according to the invention the temperature of the inner layer reaches a temperature similar or equal to the temperature of the outer layer in a shorter time. In other words, the known process in the art does not allow to have an homogenous heating of the agave piñas 102 as the time needed to reach the temperature of cooking of 110° C. is higher for the inner layer with respect to the outer layer of the agave piñas 102 while the process according to the present disclosure allows to homogeneously heat the inner, intermediate and outer layer of the agave piñas 102 such that the time needed to reach the temperature of cooking of 110° C. is substantially the same for all the layers of the agave piñas 102.

After the agave has been cooked, the process comprises one or more steps of draining the liquid solution from the plurality of agave piñas 102 from a drain line 501 connected to the autoclave 101 containing the plurality of the agave piñas 102. The liquid or liquids are further processed as known in the art.

According to an aspect, the process further comprises a step of cooling to the plurality of the agave piñas through the cooling element 200.

According to a possible embodiment the cooling step is performed by reducing the temperature inside the autoclave 101 to a temperature value inside the core portion of the plurality of the agave piñas 102 between 50° C. and 70° C. and at an absolute pressure between 0.1 to 0.3 Bar, preferably at a temperature of 60° C. and at an absolute pressure of 0.2 Bar. Advantageously the pressure is lowered in the autoclave 101 and the cooling is sped up.

According to a possible aspect, the step of cooling the cooked agave piñas 102 is carried out by reducing the pressure within the autoclave, thus performing a vacuum cooling.

Said step is performed by extracting heat from said cooked agave piñas 102. In other words, this step is performed by extracting evaporating water contained in the agave piñas 102.

This is achieved by condensing the steam inside the autoclave 101 with the heat exchanger 200a. Typically, a heat exchanger 200a comprises a circuit in which cold water passes, which allows the condensation of steam in the autoclave 101 with a reduced pressure.

As the temperature of the steam is lowered due to the cooling medium (e.g. water) flowing through the heat exchanger 200a, a portion of the steam will condensate, therefore lowering the pressure of the system.

In fact, not only the temperature is reduced, but the density of steam is also reduced. As a result, the pressure will also decrease thus also cooling down the agave present inside the autoclave.

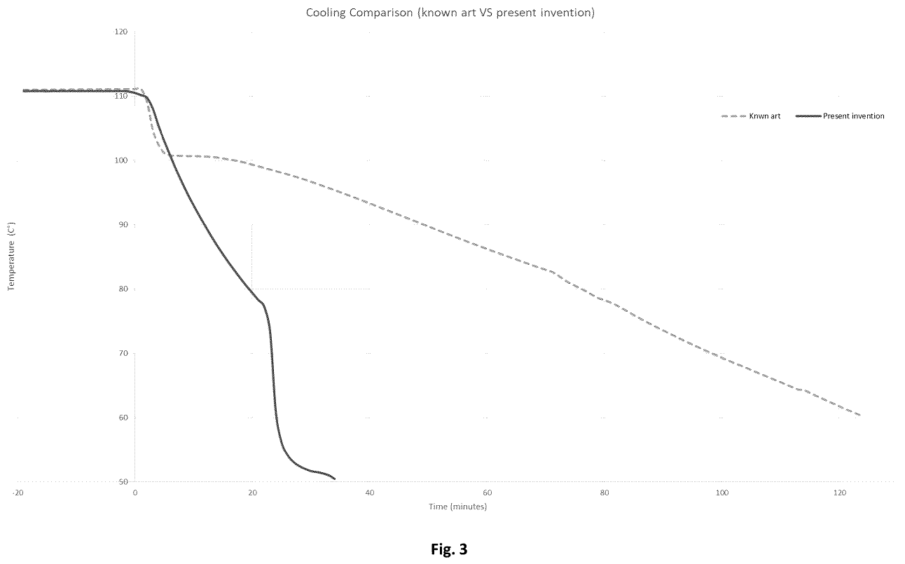

A condensate liquid is produced and can be optionally collected in the reservoir 201. Advantageously, vacuum cooling allows to reduce the time of cooling of the cooked agave piñas 102 as shown in table 2 and FIG. 3.

TABLE 2

| | | | | Average | | Time of |
|---|---|---|---|---|---|---|
| | Raw | | | Time to | Batch of | cooling |
| | agave | Cooking | Time of | reach | liquid | (to reach |
| Type of cooking of | pinãs | temperature | cooking | 110° C. | extracted | 60° C.) |
| agave pinãs | (Kg) | (° C.) | (hours) | (mins) | (g) | (mins) |
| Without vacuum | 26 | 110 | 10 | 460 | 1889 | 124 |
| heating/Without | | | | | | |
| cooling element | | | | | | |
| With vacuum | 31 | 110 | 10 | 320 | 3652 | 43 |
| heating/With | | | | | | |
| cooling element | | | | | | |

Table 2, which is referring to results gathered from a testing apparatus having a much slower steam production ability and reduced dimensions with respect to an autoclave used in the cooking process of high production volumes, provides, an example of the results obtained according to a process and system according to the present invention in which said process comprise at least a step of removing gaseous content from the autoclave and the temperature inside the autoclave is increased until 110° C. and kept for approximately 1 0 hours and cooling is applied (In table 2 said process is labelled as “With vacuum heating/With cooling element”) compared to a method known in the art in which gaseous content is not removed and there is no cooling step (In table 2 said process is labelled as “Without vacuum heating/Without cooling element”).

From values reported in Table 2 it can be concluded that the process according to the present invention is able to reach the temperature of cooking of 110° C. in a shorter time compared to a method know in the art, as already discussed above for example with reference to FIG. 4, FIG. 5 and table 1.

Additionally, as shown also in FIG. 3, the method according to the present disclosure is able to perform the cooling of the cooked agave piñas in a shorter time compared to the method without vacuum heating and without cooling.

This is also particularly relevant as, still referring to table 2 and considering a higher mass value of raw agave piña portions (31 kg), the time needed to cool the agave piña portions 102, after being cooked, is shorter (43 minutes) when vacuum heating and vacuum cooling is applied in comparison with the case in which the raw agave piña portions is lower in mass (26 Kg) and no vacuum heating and no vacuum cooling are performed. In this latest case the time needed for cooling the agave piña portions 102 is almost three times higher (124 minutes).

Advantageously the cooling of the agave piñas, according to the present invention could potentially recover thermal energy that can be used in the same apparatus or in other apparatus and eventually reused. As an example, considering an amount of cooked agave piñas equal to 1 Ton and subsequently said amount of cooked agave piñas is cooled by reducing the temperature from 110′C to 60′C, an estimated potential thermal energy recovery of about 48.4 kW can be obtained by means of the present invention.

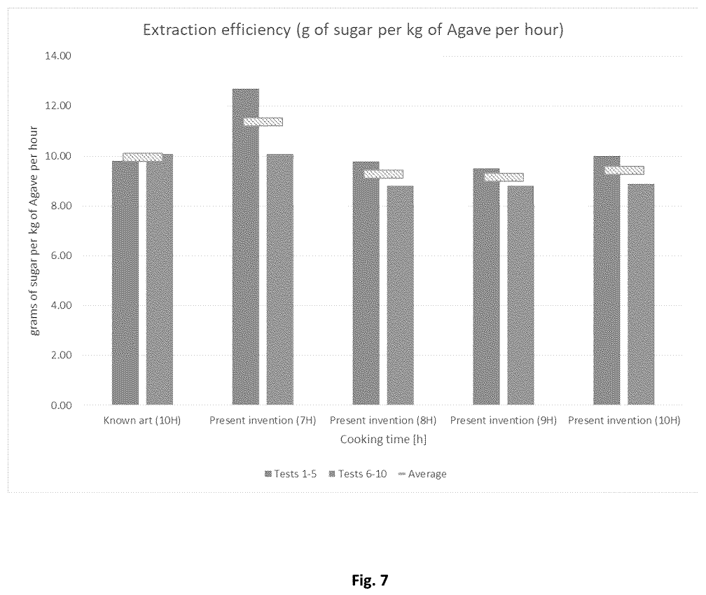

To further validate the proposed technology, a study has been carried out on the amount of sugars recovered from both the “honey” (the liquid extracted throughout the cooking process), and the juices of the cooked agave (the liquid extracted from the agave after cooking has terminated). The results, as shown in FIG. 7, show that the efficiency of extraction (sugar extractable per hour of cooking) is comparable, if not better, in the present invention.

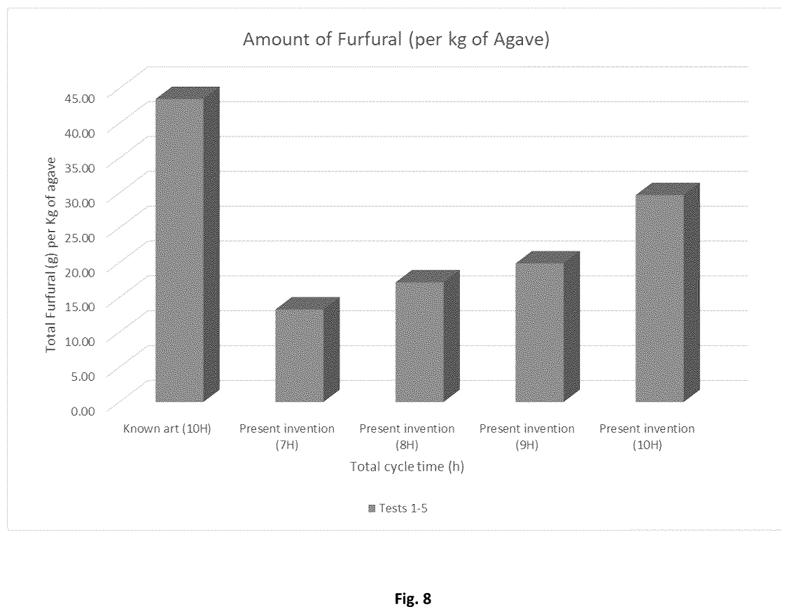

Additionally, as shown in FIG. 8, it has been proven that, from a quality point of view, the process is indeed reducing the amount of fermentable sugar lost due to burning and/or oxidation, as we can see that the amount of furfural (which is a sugar type normally found when oxidation occurs), is quite lower in tests run with the present invention rather than the process according to the known art.

Advantageously, the process above described allows to obtain homogeneously cooked and cooled agave piñas, with the highest efficiency of hydrolyzation of sugars, while maintaining at a minimum sugar oxidation/burning.

The present invention further relates to a process for cooking agave piñas 102 to produce distilled beverages comprising the steps of cooking a plurality of portions of agave piñas 102, obtaining at least a batch of liquid solution from the plurality of portion of the agave piñas 102, vacuum cooling the cooked agave piñas 102.

The step of vacuum cooling can be performed independently from the type of cooking of the agave piñas used. In particular, independently from the cooking methodology used for cooking the agave piñas by increasing the temperature thereof, such as for example the cooking methodology disclosed above comprising the step of removing gaseous content from the autoclave, a vacuum cooling step can be used with different cooking steps.

For example, the step of vacuum cooling herein disclosed and/or claimed can be applied to cooking methods known in the art, and in general to cooking methodology not requiring a removal of the gaseous content.

According to a possible aspect, said vacuum cooling of the cooked agave piñas 102 are arranged inside a closed container, preferably an autoclave 101, the vacuum cooling step is carried out by reducing the pressure within the container.

According to a possible aspect, the temperature of the steam inside the container is decreased, preferably by means of a heat exchanger 200a, a circulating cooling medium, and at least portion of the steam within the container condensates and the pressure in the container is reduced.

According to a possible aspect, the step of reducing the pressure within the container is carried out by removing or decreasing gaseous content from the container.

According to a possible aspect, the step of vacuum cooling is carried out until the temperature inside the core portion of the plurality of the agave piñas 102 is at a temperature between 50° C. and 70° C. and at an absolute pressure between 0.1 to 0.3 Bar, preferably at temperature of 60° C. and at an absolute pressure of 0.2 Bar.

1. A process for cooking agave piñas (102) to produce distilled beverages comprising the step of:
a) placing a plurality of portions of agave piñas in an autoclave (101),
b) increasing the temperature inside the autoclave in order to start the cooking of the agave piñas (102) with injection or production of steam inside said autoclave,
c) draining at least one batch of liquid solution from the plurality of portion of the agave piñas (102) from the autoclave (101),
d) cooling of the agave, either within or outside of the autoclave,
characterized in comprising at least one step of removing gaseous content from said autoclave (101).

2. Process according to claim 1, wherein the step of removing gaseous content is carried so that vacuum is applied inside the autoclave (101).

3. Process according to claim 1, comprising at least two steps of removing gaseous content from said autoclave.

4. Process according to claim 3, comprising at least two steps of removing gaseous content from said autoclave and at least two steps of increasing the temperature in said autoclave, wherein a first step of removing gaseous content is carried before the first step of increasing temperature and a second step of removing gaseous content is carried out after the first step of increasing temperature and before the second step of increasing temperature.

5. Process according to claim 4, wherein the temperature reached in the second step of increasing temperature is higher than the temperature reached in the first step of increasing temperature.

6. Process according to claim 1, wherein the step of removing gaseous content provides a reduction of the maximum pressure difference with respect to the theoretical fully saturated steam environment at any given temperature within the autoclave.

7. Process according to claim 1, wherein a first step of removing gaseous content is carried out before any heating up of the autoclave and/or of the agave portions.

8. Process according to claim 1, comprising a first step of increasing the temperature inside the autoclave.

9. Process according to claim 1, either during the first heating step, or during a following heating step, or after cooking; one or more steps of extraction of liquids produced by the agave is carried out.

10. Process according to claim 1, wherein the process for cooking the agave piñas (102) comprises a further step of heating up and maintaining a temperature value desired for the cooking and kept for a time interval between 6 hours and 15 hours.

11. Process according to claim 1, wherein the cooling of the agave comprises a step of vacuum cooling.

12. The process according to claim 11, wherein the vacuum cooling step is carried out by reducing the pressure within the autoclave.

13. The process according to claim 12, wherein the temperature of the steam inside the autoclave is decreased and at least portion of the steam within the autoclave condensates and the pressure in the autoclave is reduced.

14. The process according to claim 12, comprising the step of reducing the pressure within the autoclave by directly removing or decreasing gaseous content from the autoclave.

15. Process according to claim 11, wherein the step of vacuum cooling is carried out until the temperature inside the core portion of the plurality of the agave piñas (102) is at a temperature between 50° C. and 70° C. and at an absolute pressure between 0.1 to 0.3 Bar.

16. A system (100) for cooking agave piñas (102), the system comprising:
an autoclave (101) inside which the agave piñas are arranged in at least one basket (500), said autoclave also comprising a drain line (501),
a gaseous content removing element (103), preferably comprising a vacuum pump,
a steam generation device (104) to produce steam to be injected in the inner volume of the autoclave, or a steam generation device internal to the autoclave (101) to produce steam,
a programmable logic control unit (300).

17. The system according to claim 16, further comprising a cooling element (200).

18. The system according to claim 16, wherein the cooling element (200) comprise a heat exchanger (200a) comprising a cooling circuit wherein a cooling medium is circulated.

19. The system according to claim 16, further comprising at least one reservoir (201, 301) to recover condensate and/or other liquids produced by the cooking or cooling.

20. A process for cooking agave piñas (102) to produce distilled beverages comprising the steps of cooking a plurality of portions of agave piñas (102), obtaining at least a batch of liquid solution from the plurality of portion of the agave piñas (102), vacuum cooling the cooked agave piñas (102).

21. The process according to claim 20, wherein in said vacuum cooling step the cooked agave piñas (102) are arranged inside a closed container, the vacuum cooling step is carried out by reducing the pressure within the container.

22. The process according to claim 20, wherein the temperature of the steam inside the container is decreased, a circulating cooling medium, and at least portion of the steam within the container condensates and the pressure in the container is reduced.

23. The process according to claim 20, comprising the step of reducing the pressure within the container by directly removing or decreasing gaseous content from the container.

24. Process according to claim 20, wherein the step of vacuum cooling is carried out until the temperature inside the core portion of the plurality of the agave piñas (102) is at a temperature between 50° C. and 70° C. and at an absolute pressure between 0.1 to 0.3 Bar.

25. Process according to claim 6, any previous claims, wherein the step of removing gaseous content provides a reduction of the maximum pressure within the autoclave between 1.43 and 1.52 bar when cooking is performed at 110° C.

26. Process according to claim 10 any previous claims, wherein the process for cooking the agave piñas (102) comprises a further step of heating up and maintaining a temperature value of 110° C. for a time interval of 10 hours or less.

27. Process according to claim 15, wherein the step of vacuum cooling is carried out until the temperature inside the core portion of the plurality of the agave piñas (102) is at a temperature of 60° C. and at an absolute pressure of 0.2 Bar.
